(19) United States
(12) Patent Application Publication
(10) Pub. No.: US 2007/0153907 A1
(43) Pub. Date: Jul. 5, 2007

(54) Programmable element and hardware accelerator combination for video processing

(75) Inventors: Kalpesh D. Mehta, Chandler, AZ (US); Louis A. Lippincott, Los Altos, CA (US)

Correspondence Address: SCHWEGMAN, LUNDBERG, WOESSNER & KLUTH, P.A., P.O. BOX 2938, MINNEAPOLIS, MN, 55402, US

(73) Assignee: Intel Corporation

(21) Appl. No.: 11/323,649

(22) Filed: Dec. 30, 2005

(51) Int. Cl. H04N 11/04; H04B 1/66

(52) U.S. Cl. 375/240.24; 375/240.29

(57) ABSTRACT

In some embodiments, an apparatus comprises a hardware accelerator to execute one or more process operations on one or more pixels of a macroblock of a video frame that is based on a video standard. The apparatus also comprises a programmable element to process a configuration header of the macroblock. The programmable element configures one or more parameters of the one or more process operations of the hardware accelerator for the video standard based on the configuration header.

### TECHNICAL FIELD

The application relates generally to data processing, and, more particularly, to decoding of data.

### BACKGROUND

Encoding, transmitting, and decoding of different types of signals can be a bandwidth intensive process. Typically, an analog signal is converted into a digital form compressed and transmitted as a bit stream over a suitable communication network. After the bit stream arrives at the receiving location, a decoding operation converts the compressed bit stream into a digital image and played back. However, the encoding and decoding operations may be based on a number of different standards (e.g., Moving Pictures Experts Group (MPEG)-2, MPEG-4, Windows Media (WM)-9, etc.). Accordingly, the logic used to perform the encoding and decoding operations must be designed to process one or more of these standards.

### BRIEF DESCRIPTION OF THE DRAWING

Embodiments of the invention may be best understood by referring to the following description and accompanying drawing that illustrate such embodiments. The numbering scheme for the Figures included herein is such that the leading number for a given reference number in a Figure is associated with the number of the Figure. For example, a system 100 can be located in FIG. 1. However, reference numbers are the same for those elements that are the same across different Figures. In the drawings:

FIG. 1 illustrates a block diagram of a video decoder, according to some embodiments of the invention.

FIG. 2 illustrates a more detailed block diagram of a variable length decoder, according to some embodiments of the invention.

FIG. 3 illustrates various packets being generated by a variable length decoder, according to some embodiments of the invention.

FIG. 4 illustrates a more detailed block diagram of a run level decoder, according to some embodiments of the invention.

FIG. 5 illustrates a more detailed block diagram of an inverse DCT logic, according to some embodiments of the invention.

FIG. 6 illustrates a more detailed block diagram of a motion compensation logic, according to some embodiments of the invention.

FIG. 7 illustrates a more detailed block diagram of a deblock filter, according to some embodiments of the invention.

FIG. 8 illustrates a flow diagram for decoding, according to some embodiments of the invention.

FIG. 9 illustrates a processor architecture with modules having separate programmable elements and hardware accelerators, according to some embodiments of the invention.

### DETAILED DESCRIPTION

Embodiments of the invention are described in reference to a video decoding operation. However, embodiments are not so limited. Embodiments may be used in any of a number of different applications (encoding operations, etc.).

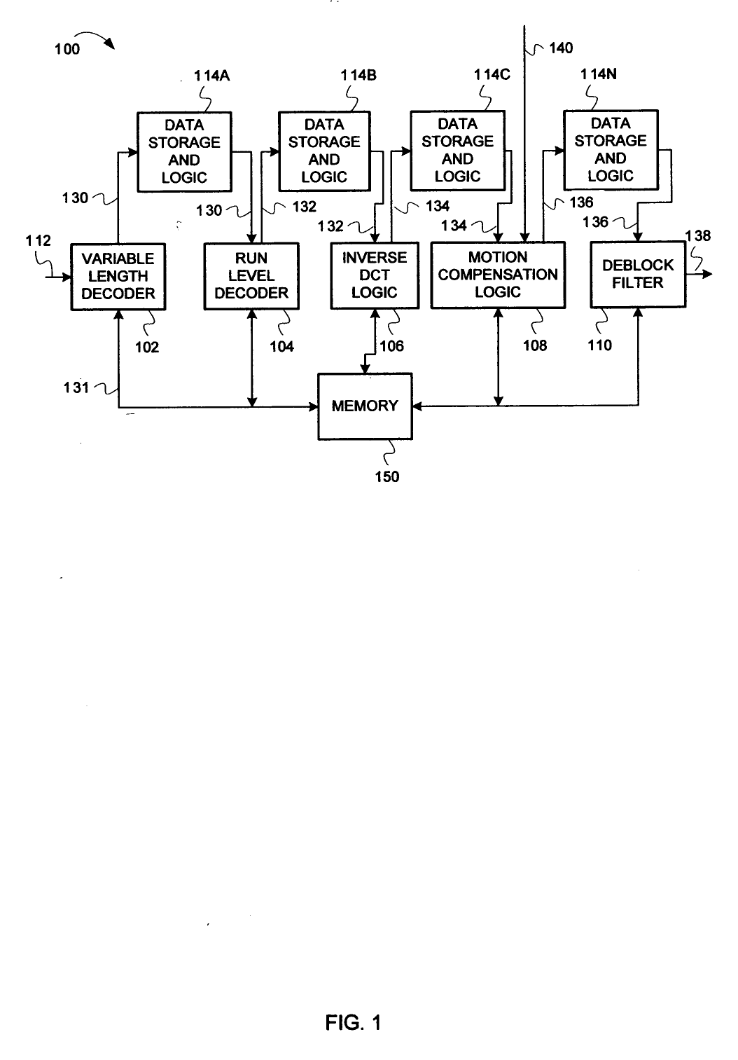

FIG. 1 illustrates a block diagram of a video decoder, according to some embodiments of the invention. In particular, FIG. 1 illustrates a system 100 that includes a variable length decoder 102, a run level decoder 104, an inverse Discrete Cosine Transform (DCT) logic 106, a motion compensation logic 108, a deblock filter 110, data storage and logic 114A-114N and a memory 150. The variable length decoder 102, the run level decoder 104, the inverse DCT logic 106, the motion compensation logic 108 and the deblock filter 110 may be representative of hardware, software, firmware or a combination thereof.

The data storage and logic 114A-114N and the memory 150 may include different types of machine-readable media. For example, the machine-readable medium may be volatile media (e.g., random access memory (RAM), magnetic disk storage media, optical storage media, flash memory devices, etc.). The machine-readable medium may be different types of RAM (e.g., Synchronous Dynamic RAM (SDRAM), DRAM, Double Data Rate (DDR)-SDRAM, etc.).

The variable length decoder 102 is coupled to receive a compressed bit stream 112. In some embodiments, the compressed bit stream 112 may be encoded data that is coded based on any of a number of different decoding standards. Examples of the different coding standards include Motion Picture Experts Group (MPEG)-2, MPEG-4, Windows Media (WM)-9, etc. For more information regarding various MPEG-2 standards, please refer to “International Organization for Standardization (ISO)/International Electrotechnical Commission (IEC) 13818-2:2000 Information Technology—Generic Coding of Moving Pictures and Associated Audio Information: Video” and related amendments. For more information regarding various MPEG-4 standards, please refer to “ISO/IEC 14496 Coding of Audio-Visual Objects—Part 2: Video” and related amendments.

As further described below, the variable length decoder 102 may generate sequence packets, frame packets and macroblock packets 131 based on the compressed bit stream 112. The variable length decoder 102 may store the sequence packets, the frame packets and the headers of the macroblock packets into the memory 150. The variable length decoder 102 may store both of the macroblock packets into the data storage and logic 114A. As shown, the variable length decoder 102, the run level decoder 104, the inverse DCT logic 106, the motion compensation logic 108 and the deblock filter 110 are coupled to the memory 150. Therefore, the run level decoder 104, the inverse DCT logic 106, the motion compensation logic 108 and the deblock filter 110 may access the sequence packets, the frame packets and the headers of the macroblock packets in the memory 150 for processing of the body of the macroblock packets.

The run level decoder 104 is coupled to receive the bodies of the macroblock packets 131 from the data storage and logic 114A. The run level decoder 104 may generate coefficient data 132 based on this information. The run level decoder 104 is coupled to store the coefficient data 132 into the data storage and logic 114B. The inverse DCT logic 106 is coupled to receive the coefficient data 132 from the data storage and logic 114B. The inverse DCT logic 106 may generate pixels 134 based on the coefficient data 132. For example, the inverse DCT logic 106 may generate pixels for I-frames or residues for the P-frames. The inverse DCT logic 106 is coupled to store the pixels 134 into the data storage and logic 114C.

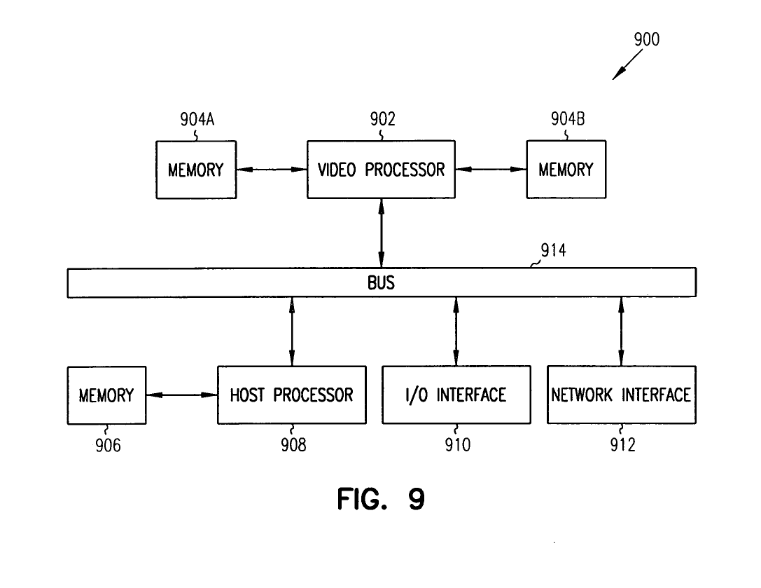

The motion compensation logic 108 is coupled to receive the pixels 134 from the data storage and logic 114C and to receive reference pixels 140. The motion compensation logic 108 may receive the reference pixels 140 from a memory not shown. For example, the motion compensation logic 108 may receive the reference pixels from the memory 904A or the memory 925B (shown in FIG. 9 (which is described in more detail below). The motion compensation logic 108 may generate pel data 136 based on the pixels 134 and the reference pixels 140. The motion compensation logic 108 is coupled to store the pel data 136 into the data storage and logic 114N. The deblock filter 112 is coupled to receive the pel data 136 from the data storage and logic 114N. The deblock filter 112 may generate pel output 122 based on the pel data 136.

In some embodiments, the compressed bit stream 112 may have been encoded based on any of a number of coding standards. One or more of the standards may require at least some operations that are specific to that standard. The variable length decoder 102 does not necessarily perform the decode operations for each standard differently. Rather, there are some core operations of the decode operations that are common across the different standards. Examples of such core operations are described in more detail below.

In some embodiments, any of the variable length decoder 102, the run level decoder 104, the inverse DCT logic 106, the motion compensation logic 108 and the deblock filter 110 may include a hardware accelerator and a programmable element. In some embodiments, the programmable element may control the operation of the hardware accelerator. Additionally, the programmable element may perform operations that are unique/specific to a particular coding standard. The hardware accelerator may perform core operations that may be common across multiple coding standards. In some embodiments, the standards may vary based on the sequence of these core functions. Accordingly, the variable length decoder 102, the run level decoder 104, the inverse DCT logic 106, the motion compensation logic 108 and the deblock filter 110 may allow for faster execution of the core functions, while allowing for the programmability across the different standards.

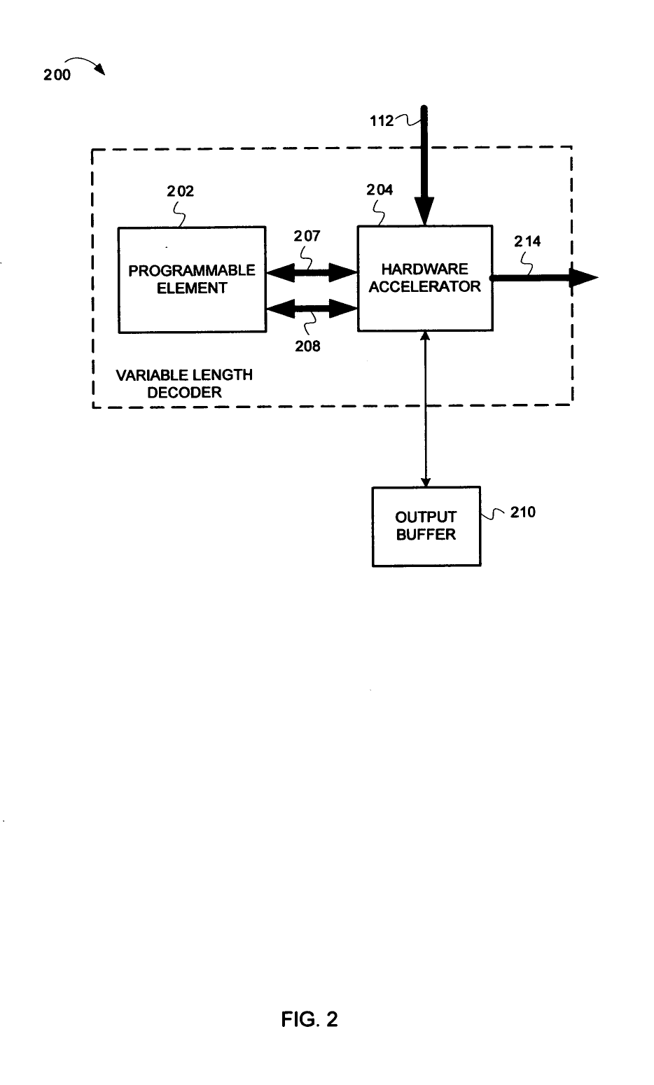

A number of different configurations of a programmable element in combination with a hardware accelerator for video processing are now described. In particular, FIGS. 2-6 illustrate different configurations for different operations that are part of the video decoding of a data stream, according to some embodiments of the invention. In some embodiments, the programmable element and the hardware accelerator process macroblocks of pixels in a video frame for a number of video frames. In some embodiments, the programmable element may process a macroblock header that includes data for setting one or more parameters of the hardware accelerator. In particular, the programmable element may set certain of these parameters that are specific to given coding standards. The programmable element may cause data to be input into the hardware accelerator. Moreover, the configurations and data input into the hardware accelerator may vary for each macroblock, blocks within a macroblock, for a video frame of macroblocks, for a video sequence of video frames of macroblocks, etc.

FIG. 2 illustrates a more detailed block diagram of a variable length decoder, according to some embodiments of the invention. In particular, FIG. 2 illustrates a more detailed block diagram of the variable length decoder 102, according to some embodiments of the invention. The variable length decoder 200 includes a programmable element 202 and a hardware accelerator 204. The hardware accelerator 204 is coupled to an output buffer 210.

The hardware accelerator 204 receives the compressed bit stream 112. The hardware accelerator 204 is coupled to transmit and receive data through a data channel 207 to and from the programmable element 202. The programmable element 202 is also coupled to transmit commands through a command channel 208 to the hardware accelerator 204 for control thereof. For example, the commands may set different parameters for the process operations performed by the hardware accelerator 204. In some embodiments, the hardware accelerator 204 may be configured for a particular standard by the programmable element 202. For example, the programmable element may load a set of tables that the hardware accelerator 204 may used to decode the compressed bit stream 112. Both the programmable element 202 and the hardware accelerator 204 may access the output buffer 210. For example, the programmable element 202 and the hardware accelerator 204 may store the packets (including the sequence, frame and macroblock packets) into the output buffer 210. In some embodiments, the programmable element 202 and the hardware accelerator 204 may use the output buffer 210 in generating the packets. For example, one or more operations by the programmable element 202 and the hardware accelerator 204 may generate a first part of a packet (e.g., a header of one of the packets), which is intermediately stored in the output buffer 210. Subsequently, one or more operations by the programmable element 202 and the hardware accelerator 204 may generate a second part of the packet (e.g., the body of this packet). The programmable element 202 or the hardware accelerator 204 may generate the packet based on the two different parts.

The programmable element 202 may transmit a control command through the command channel 208 to the hardware accelerator 204, thereby causing the hardware accelerator 204 to output these packets for storage into the memory 150 and the data storage and logic 114A. In some embodiments, both the programmable element 202 and the hardware accelerator 204 decode different parts of the compressed bit stream 112.

For example, the programmable element 202 may decode the bitstream that is specific to a particular standard. The hardware accelerator 204 may be programmed by the programmable element 202 to perform the decoding operations that are common to the standards. In other words, the hardware accelerator 204 may perform various core operations that may be common across a number of standards.

Examples of core operations may relate to parsing of the bits in the bit stream. For example, a core operation may include locating a pattern of bits in the bit stream. The core operation may include locating a variable length code in the bit stream. For example, the core operation may include locating a specified start code in the bit stream. In some embodiments, the core operation may include the decoding of the bits in the bit stream. The core operation may retrieve a number of bits from the bit stream and may decode such bits. In particular, the core operation may perform a look-up into a table (based on the retrieved bits). The hardware accelerator 204 may then interpret the decoded bits as index, (run, level, last) triplet, etc. In some embodiments, the hardware accelerator 204 may output the decoded bits from the variable length decoder 102 without further processing by the programmable element 202. Alternatively, the hardware accelerator 204 may return the result of the decode operation to the programmable element 202 for further processing. In some embodiments, the programmable element 202 may output either packed or unpacked formatted data to the hardware accelerator 204. If packed data is received, the hardware accelerator 204 may unpack the packed data for further processing.

Another core operation that may be performed by the hardware accelerator 204 may include decoding a block of coefficients. In particular, the hardware accelerator 204 may decode the compressed bit stream 112 until a whole block of coefficients is decoded. The hardware accelerator 204 may output the decoded block from the variable length decoder 102 without further processing by the programmable element 202. Alternatively, the hardware accelerator 204 may return the result of the decode operation to the programmable element 202 for further processing.

Another core operation performed by the hardware accelerator 204 may include the retrieval of a specified number of bits from the compressed bit stream 112, which may be forwarded to the programmable element 202 for further processing (as described below). Another core operation performed by the hardware accelerator 204 may include showing a specified number of bits from the compressed bit stream 112 to the programmable element 202 (without removal of such bits from the bit stream).

A more detailed description of the allocation of the decoding operations between the programmable element 202 and the hardware accelerator 204, according to some embodiments, is now set forth. The compressed bit stream 112 may include bits for a number of frames. For example, the compressed bit stream 112 may include frames of video. A sequence includes a number of the frames. For example, a one-second sequence may include 30 frames. A frame of video may be partitioned into a number of macroblocks. Moreover, the macroblocks may include a number of blocks. Based on the compressed bit stream 112, the variable length decoder 102 may generate packets that include the sequence level data, the frame level data and the macroblock data.

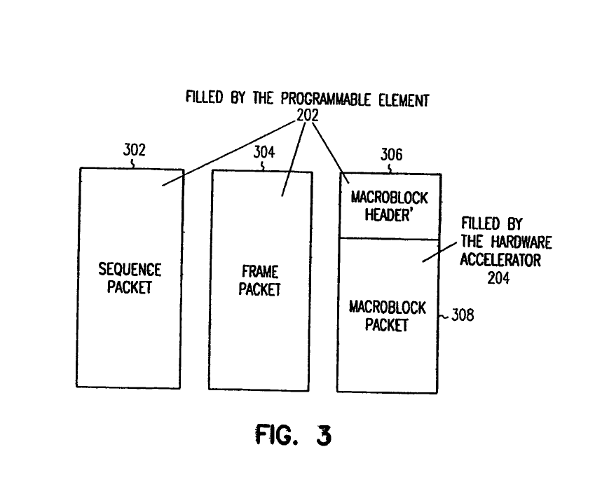

Accordingly, FIG. 3 illustrates various packets being generated by a variable length decoder, according to some embodiments of the invention. In particular, FIG. 3 illustrates various packets being generated by the variable length decoder 102, according to some embodiments of the invention. As shown, the variable length decoder 102 may generate a sequence packet 302, a frame packet 304, a macroblock header 306 and a macroblock packet 308.

The sequence packet 302 may include the sequence level parameters decoded from the compressed bit stream 112. The sequence level parameters may include the size of the frames, the type of code used for the decoding, etc. The frame packet 304 may include frame level parameters decoded from the compressed bit stream 112. The frame level parameters may include the type of frame, whether level shifting is needed, whether quantization is needed, etc. The macroblock header 306 includes macroblock control information. The macroblock control information may include the type of encoding used to encode the macroblock data, the type and number of blocks therein, which blocks are within the compressed bit stream, whether motion prediction is used and for which blocks, the motion vectors for the motion prediction, etc.). The macroblock packet 308 may include the macroblock data from the compressed bit stream 112.

In some embodiments, the decoding of the sequence parameters may be specific to a particular coding standard. In some embodiments, the decoding of the frame level parameters may be specific to a particular coding standard. In some embodiments, the generation of the macroblock header 306 may be specific to a particular coding standard. The decoding of the macroblock packet may be based on at least partially on core operations that are common across multiple coding standards (as described above).

In some embodiments, the programmable element 202 may decode the packets that are specific to a particular decoding standard, while the hardware accelerator 204 may decode the packets that are at least partially common across multiple coding standards. Accordingly, as shown, the programmable element 202 may decode the sequence parameters for generation of the sequence packets 302. The programmable element 202 may also decode the frame-level parameters for generation of the frame packets 304.

Therefore, the hardware accelerator 204 may be hard-wired to perform core operations that are common across multiple coding standards. The programmable element 202 may be programmable to handle the specifics of a particular standard. Accordingly, the instructions executed in the programmable element 202 may be updated to allow for the processing of new or updated standards. However, embodiments are not so limited. In some embodiments, the programmable element 202 may decode parts of the packets that are common across multiple standards. In some embodiments, the hardware accelerator 204 may decode parts of the packets that are specific to a particular standard.

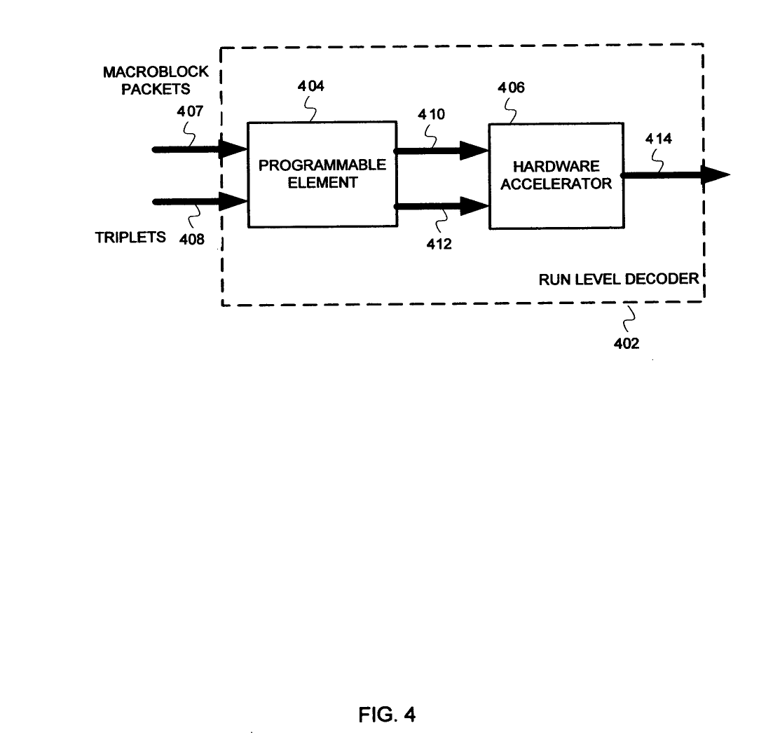

FIG. 4 illustrates a more detailed block diagram of a run level decoder, according to some embodiments of the invention. In particular, FIG. 4 illustrates a more detailed block diagram of a run level decoder 402, which may be representative of the run level decoder 104, according to some embodiments of the invention. The run level decoder 402 includes a programmable element 404 and a hardware accelerator 406. The run level decoder 402 may receive triplets and macroblock packets (both data and configuration packets) from the variable length decoder 102 and expand the triplets to generate coefficients. The run level decoder 402 may also reformat the macroblock configuration packets, depending on the configuration of the other components downstream (e.g., the inverse DCT logic 106, the motion compensation logic 108, the deblock filter 110).

The programmable element 404 is coupled to receive macroblock packets 407 (both data and configuration packets) and triplets 408 from the variable length decoder 102. The programmable element 404 processes the headers of the macroblock packets 407. Based on the processing, the programmable element 404 outputs commands 412 that are input into the hardware accelerator 406. The commands may set different parameters for the process operations performed by the hardware accelerator 406.

The programmable element 404 forwards data 410 to the hardware accelerator 406. In some embodiments, the hardware accelerator 406 may include two or more buffers for storage of data therein. A macroblock packet may include a number of blocks of data. For example, a macroblock packet may include a block for a Y (luma)-part, a block for a U (chroma)-part and a block for a V (chroma)-part for a part of a frame of data. Moreover, each block in the macroblock may be partitioned into one or more sub-blocks.

The commands 412 may indicate the number and sizes of blocks and sub-blocks with a macroblock being processed. The commands 412 may also indicate whether there is data for a given block or data for sub-blocks within the block. In particular, in some embodiments, based on the type of compression, the type of data, data in the other sub-blocks, etc., data for some of the sub-blocks may not be transferred to the video decoder.

For a given block/sub-block that is within the macroblock packet 407, the hardware accelerator 406 may receive the compressed data for the block/sub-block and expand the compressed data for storage into one of the buffers therein. The hardware accelerator 406 may expand the compressed data using the triplets. The hardware accelerator 406 may perform the reverse operation used to compress the data to expand the data. The hardware accelerator 406 may then store the results of these operations into one of these internal buffers.

In some embodiments, if the commands 412 indicate that no data is within a block, the hardware accelerator 406 may fill this part of the frame with zeroes within the current internal buffer being written to. Similarly, if the commands 412 indicate that no data is within a sub-block of a macroblock, the hardware accelerator 406 may fill this part of the frame with zeroes within the current internal buffer being written to.

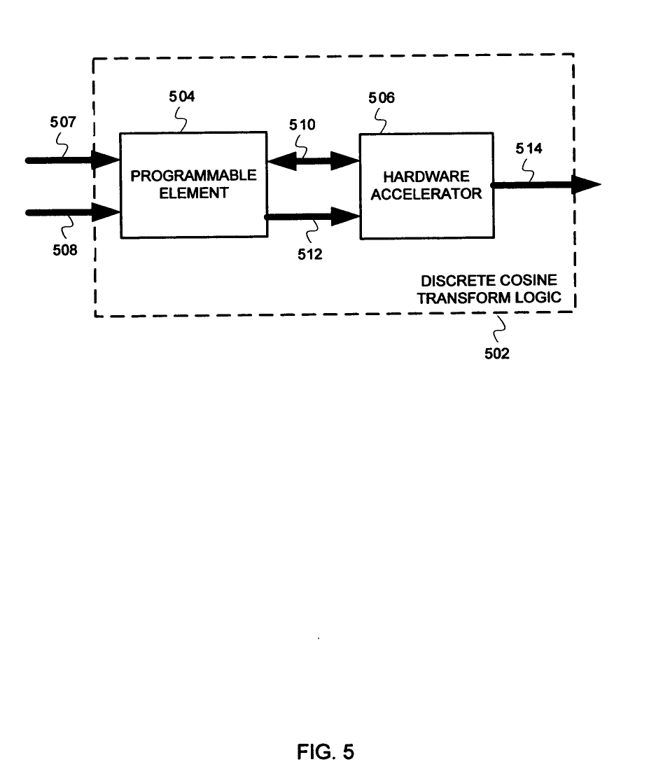

FIG. 5 illustrates a more detailed block diagram of an inverse DCT logic, according to some embodiments of the invention. In particular, FIG. 5 illustrates a more detailed block diagram of an inverse DCT logic 502, which may be representative of the inverse DCT logic 106, according to some embodiments of the invention. The inverse DCT logic 502 includes a programmable element 504 and a hardware accelerator 506. The inverse DCT logic 502 may perform prediction operations using reference data from adjacent macroblocks.

The programmable element 504 is coupled to receive a macroblock header 507 and data 508. The macroblock header 507 may store data that indicates whether a prediction is performed, the type of block, the size of the blocks within the macroblock on which inverse transforms may be performed, etc. For example, for an 8×8 macroblock, the size may be an 8×8 block, two 8×4 blocks, two 4×8 blocks, four 4×4 blocks, etc.

The data 508 may include the macroblock. The programmable element 504 may forward the macroblock to the hardware accelerator 506 for processing (shown as data transfer 510). The programmable element 504 may configure the hardware accelerator 506 according to different parameters (as described above). The hardware accelerator 506 may perform the prediction operations for the macroblock based on the configuration. For example, the hardware accelerator 506 may perform the inverse quantization, inverse transform, etc. Also as shown, the data transfer 510 is a bilateral communication. Accordingly, the programmable element 504 may perform some, all or none of the pixel processing. For example, the programmable element 504 may perform part of the inverse quantization, inverse transform, etc.

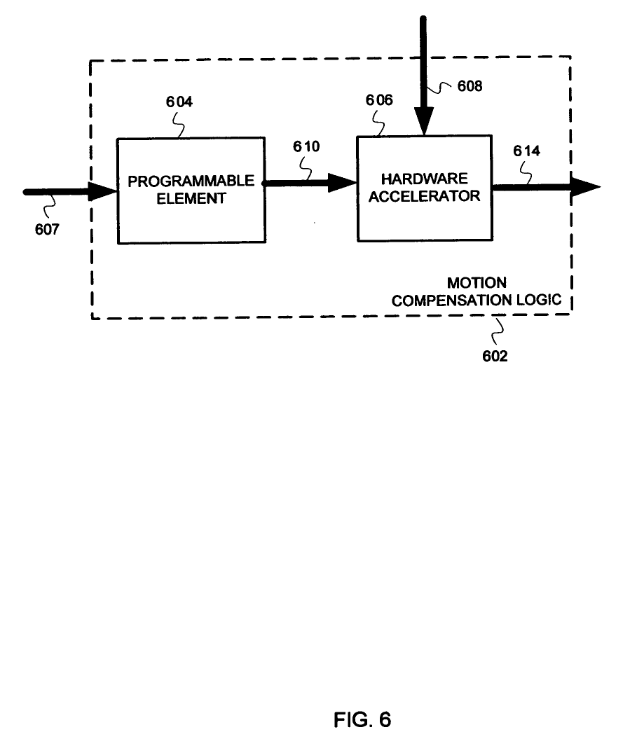

FIG. 6 illustrates a more detailed block diagram of a motion compensation logic, according to some embodiments of the invention. In particular, FIG. 6 illustrates a more detailed block diagram of a motion compensation logic 602, which may be representative of the motion compensation logic 108, according to some embodiments of the invention. The motion compensation logic 602 includes a programmable element 604 and a hardware accelerator 606. The motion compensation logic 602 may perform motion compensation of the received macroblocks to reduce temporal redundancy of the video data stream.

The programmable element 604 is coupled to receive a macroblock header 607. The hardware accelerator 606 is coupled to receive data 608. With reference to FIG. 1, in some embodiments, the hardware accelerator 606 may receive the data from the data storage and logic 114C. The data 608 may include the reference pixels that are used as a reference to generate the predictive macroblocks. The macroblock header 607 may store data that includes one or more motion vectors for the motion compensation. The macroblock header 607 may store an indication of whether interpolation is performed and the type of interpolation that needs to be performed (horizontal, vertical or both). The programmable element 604 may parse the macroblock header 607. The programmable element 604 may perform any address translation to locate the reference pixels 140. In particular, the macroblock header 607 may include the identification of the frame that needs to be used as a reference as well as the block within that frame that should be used as a reference block (for interpolation). In some embodiments, the programmable element 604 reads the motion vector data from the macroblock header 607. The programmable element 604 may then convert this data into an address of the block in the reference frame that is used as the reference block for interpolation. The programmable element 604 may then cause the control logic in the data storage and logic 114C to read these reference pixels for loading into the motion compensation logic 108.

The programmable element 604 may input (shown as 610) the one or more motion vectors from the macroblock header 607 into the hardware accelerator 606. The programmable element 604 may also input (shown as 610) different commands to set parameters for the process operations performed by the hardware accelerator 606. For example, the programmable element 604 may set parameters of whether and the type of interpolation to be performed as part of the motion compensation. Accordingly, the hardware accelerator 606 performs the processing of the pixels based on the information from the macroblock header 607 that is processed by the programmable element 604. Each macroblock may be processed differently depending on the data in the macroblock header 607. For example, an indication of whether motion compensation is performed, the number and type of motion vectors, whether and the type of interpolation, etc. may be different for each of the macroblocks. Therefore, the programmable element 604 may process each macroblock header 607 and then configure the hardware accelerator 606 to execute the motion compensation accordingly.

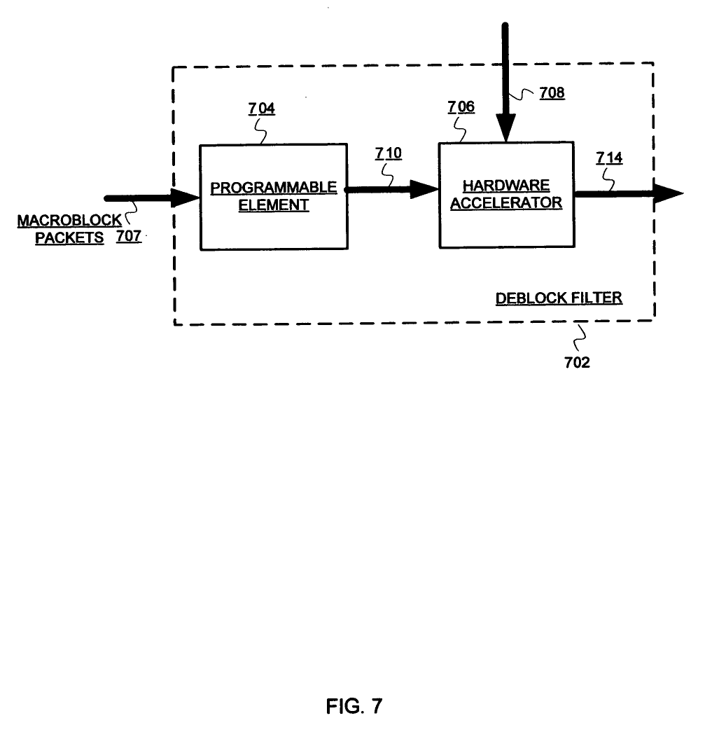

FIG. 7 illustrates a more detailed block diagram of a deblock filter, according to some embodiments of the invention. In particular, FIG. 7 illustrates a more detailed block diagram of a deblock filter 702, which may be representative of the deblock filter 108, according to some embodiments of the invention. The deblock filter 702 includes a programmable element 704 and a hardware accelerator 706. The deblock filter 702 may filter edges of blocks to smooth out blockiness along the block edges.

The programmable element 704 is coupled to receive macroblock packets 707. The programmable element 704 processes the headers of the macroblock packets 707. The programmable element 704 is coupled to transmit commands 710 to the hardware accelerator 706 based on processing of the headers. The programmable element 704 may set parameters related to the process operations performed by the hardware accelerator 706. The hardware accelerator 706 is coupled to receive data 708, which may be the macroblocks. The hardware accelerator 706 may process the data 708 based on the commands 710. The hardware accelerator 706 may perform filtering of the edges of the macroblocks. Accordingly, the hardware accelerator 706 performs the processing of the data based on the commands 710 from the programmable element 704. Each macroblock may be processed differently depending on the data in the macroblock header. For example, the commands 710 may include whether to perform filtering, which edges are to be filtered, the type of filtering for the edges (which may or may not be independent of each other). The programmable element 704 may determine whether to filter based on a number of different criteria. For example, the programmable element 704 may compare the quantization levels or motion vectors of two adjacent macroblocks to determine whether the edges of one should be filtered. The hardware accelerator 706 may use different types of filters, such as different types of nonlinear filters.

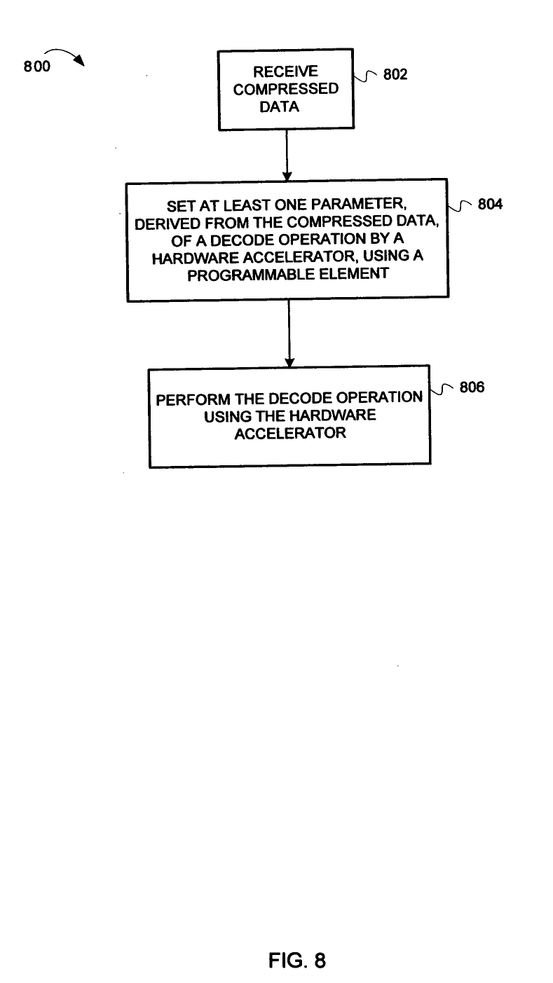

A more detailed description of the operations of any of the variable length decoder 102, the run level decoder 104, the inverse DCT logic 106, the motion compensation logic 108 or the deblock filter 110, according to some embodiments, is now set forth. In particular, FIG. 8 illustrates a flow diagram for decoding, according to some embodiments of the invention. The flow diagram 800 is described with reference the variable length decoder 200 illustrated in FIG. 2. However, the operations in the flow diagram 800 are applicable to the run level decoder 402, the inverse DCT logic 502, the motion compensation logic 602 or the deblock filter 702 illustrated in FIGS. 4-7, respectively. The flow diagram 800 commences at block 802.

At block 802, the compressed data is received. With reference to FIG. 2, the hardware accelerator 204 may receive the compressed data (shown as the compressed bit stream 112). Control continues at block 804.

At block 804, at least one parameter, which is derived from the compressed data and is for a decode operation performed by a hardware accelerator, is set by a programmable element. With reference to FIG. 2, the programmable element 202 may set this at least one parameter. For example, the programmable element 202 may set different parameters related to the core operations to be performed by the hardware accelerator 204, as part of the variable length decode operation (as described above). Control continues at block 806.

At block 806, the decode operation is performed using the hardware accelerator. With reference to FIG. 2, the hardware accelerator 204 may perform this decode operation using the parameters set by the programmable element 202 (as described above).

The decoder architecture described herein may operate in a number of different environments. An example architecture, according to some embodiments, is now described. In particular, FIG. 9 illustrates a processor architecture with modules having separate programmable elements and hardware accelerators, according to some embodiments of the invention. FIG. 9 illustrates a system 900 that includes a video processor 902 that includes the architecture with modules having separate programmable elements and hardware accelerators, as described above. For example, the video processor 902 may include the components of the system 100 of FIG. 1.

The video processor 902 is coupled to memories 904A-904B. In some embodiments, the memories 904A-904B are different types of random access memory (RAM). For example, the memories 904A-904B are double data rate (DDR) Synchronous Dynamic RAM (SDRAM).

The video processor 902 is coupled to a bus 914, which in some embodiments, may be a Peripheral Component Interface (PCI) bus. The system 900 also includes a memory 906, a host processor 908, a number of input/output (I/O) interfaces 910 and a network interface 912. The host processor 908 is coupled to the memory 906. The memory 906 may be different types of RAM (e.g., Synchronous RAM (SRAM), Synchronous Dynamic RAM (SDRAM), DRAM, DDR-SDRAM, etc.), while in some embodiments, the host processor 908 may be different types of general purpose processors. The I/O interface 910 provides an interface to I/O devices or peripheral components for the system 900. The I/O interface 910 may comprise any suitable interface controllers to provide for any suitable communication link to different components of the system 900. The I/O interface 910 for some embodiments provides suitable arbitration and buffering for one of a number of interfaces.

For some embodiments, the I/O interface 910 provides an interface to one or more suitable integrated drive electronics (IDE) drives, such as a hard disk drive (HDD) or compact disc read only memory (CD ROM) drive for example, to store data and/or instructions, for example, one or more suitable universal serial bus (USB) devices through one or more USB ports, an audio coder/decoder (codec), and a modem codec. The I/O interface 910 for some embodiments also provides an interface to a keyboard, a mouse, one or more suitable devices, such as a printer for example, through one or more ports. The network interface 912 provides an interface to one or more remote devices over one of a number of communication networks (the Internet, an Intranet network, an Ethernet-based network, etc.).

The host processor 908, the I/O interfaces 910 and the network interface 912 are coupled together with the video processor 902 through the bus 914. Instructions executing within the host processor 908 may configure the video processor 902 for different types of video processing. For example, the host processor 908 may configure the different components of the video processor 902 for decoding operations therein. Such configuration may include the types of data organization to be input and output from the data storage and logic 114 (of FIG. 1), whether the pattern memory 224 is used, etc. In some embodiments, the encoded video data may be input through the network interface 912 for decoding by the components in the video processor 902.

In the description, numerous specific details are set forth. However, it is understood that embodiments of the invention may be practiced without these specific details. In other instances, well-known circuits, structures and techniques have not been shown in detail in order not to obscure the understanding of this description. Numerous specific details such as logic implementations, opcodes, ways of describing operands, resource partitioning/sharing/duplication implementations, types and interrelationships of system components, and logic partitioning/integration choices are set forth in order to provide a more thorough understanding of the inventive subject matter. It will be appreciated, however, by one skilled in the art that embodiments of the invention may be practiced without such specific details. In other instances, control structures, gate level circuits and full software instruction sequences have not been shown in detail in order not to obscure the embodiments of the invention. Those of ordinary skill in the art, with the included descriptions will be able to implement appropriate functionality without undue experimentation.

References in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Embodiments of the invention include features, methods or processes that may be embodied within machine-executable instructions provided by a machine-readable medium. A machine-readable medium includes any mechanism that provides (i.e., stores and/or transmits) information in a form accessible by a machine (e.g., a computer, a network device, a personal digital assistant, manufacturing tool, any device with a set of one or more processors, etc.). In an exemplary embodiment, a machine-readable medium includes volatile and/or non-volatile media (e.g., read only memory (ROM), random access memory (RAM), magnetic disk storage media, optical storage media, flash memory devices, etc.), as well as electrical, optical, acoustical or other form of propagated signals (e.g., carrier waves, infrared signals, digital signals, etc.)).

Such instructions are utilized to cause a general-purpose or special-purpose processor, programmed with the instructions, to perform methods or processes of the embodiments of the invention. Alternatively, the features or operations of embodiments of the invention are performed by specific hardware components that contain hard-wired logic for performing the operations, or by any combination of programmed data processing components and specific hardware components. Embodiments of the invention include software, data processing hardware, data processing system-implemented methods, and various processing operations, further described herein.

A number of figures show block diagrams of systems and apparatus for a decoder architecture, in accordance with some embodiments of the invention. A figure shows a flow diagram illustrating operations of a decoder architecture, in accordance with some embodiments of the invention. The operations of the flow diagram have been described with reference to the systems/apparatus shown in the block diagrams. However, it should be understood that the operations of the flow diagram may be performed by embodiments of systems and apparatus other than those discussed with reference to the block diagrams, and embodiments discussed with reference to the systems/apparatus could perform operations different than those discussed with reference to the flow diagram.

In view of the wide variety of permutations to the embodiments described herein, this detailed description is intended to be illustrative only, and should not be taken as limiting the scope of the inventive subject matter. What is claimed, therefore, are all such modifications as may come within the scope and spirit of the following claims and equivalents thereto. Therefore, the specification and drawings are to be regarded in an illustrative rather than a restrictive sense.

What is claimed is:

1. An apparatus comprising:
a hardware accelerator to execute one or more process operations on one or more pixels of a macroblock of a video frame that is based on a video standard; and
a programmable element to process a configuration header of the macroblock, the programmable element to configure one or more parameters of the one or more process operations of the hardware accelerator for the video standard based on the configuration header, the programmable element to execute at least one of the one or more process operations.

2. The apparatus of claim 1, wherein the one or more process operations comprises a variable length decode operation.

3. The apparatus of claim 2, wherein the hardware accelerator is to perform a core operation that is common for the video standard and a different video standard.

4. The apparatus of claim 1, wherein the one or more process operations comprises a deblock filter operation.

5. The apparatus of claim 4, wherein the hardware accelerator is to filter an edge of a block within the video frame.

6. The apparatus of claim 5, wherein the one or more parameters comprises a type of filter and an identifier of the edge.

7. The apparatus of claim 1, wherein the one or more process operations comprises a run level decoding.

8. The apparatus of claim 7, wherein the hardware accelerator is to receive the one or more pixels as compressed data, wherein the one or more process operations comprises an expansion of the compressed data based on one or more triplets.

9. The apparatus of claim 7, wherein the one or more parameters comprises an indicator of whether there is data stored for a block or sub-block within the macroblock.

10. The apparatus of claim 1, wherein the one or more process operations comprises a motion compensation.

11. The apparatus of claim 10, wherein the programmable element is to input a motion vector, processed from the configuration header, to the hardware accelerator and to cause a reference block to be input into the hardware accelerator.

12. The apparatus of claim 10, wherein the one or more parameters comprises a type of interpolation for the motion compensation.

13. The apparatus of claim 1, wherein the one or more process operations comprises an inverse transform operation or an inverse quantization operation.

14. The apparatus of claim 13, wherein the inverse transform operation comprises a Discrete Cosine Transform operation.

15. The apparatus of claim 13, wherein the one or more parameters comprises a size of a block within the macroblock on which the inverse transform operation or the inverse quantization operation is performed.

16. A system comprising:
a Synchronous RAM (SRAM);
a variable length decoder comprising,
a first hardware accelerator to a variable length decode operation of a compressed bit stream to output macroblock packets into the SRAM based on the first control command; and
a first programmable element to configure a parameter of the variable length decode operation; and
a run level decoder comprising,
a second hardware accelerator to retrieve the macroblock packets from the SRAM and to perform a run level decode operation to generate coefficient data based on the macroblock packets; and
a second programmable element to configure a parameter of the run level decode operation.

17. The system of claim 16, further comprising an inverse Discrete Cosine Transform (DCT) logic comprising,
a third hardware accelerator to perform an inverse transform operation on the coefficient data to generate pixels for one or more data frames; and
a third programmable element to configure a parameter of the inverse transform operation.

18. The system of claim 17, further comprising a motion compensation logic comprising,
a fourth hardware accelerator to perform a motion compensation operation on the pixels for one or more data frames; and
a fourth programmable element to configure a parameter of the motion compensation operation.

19. A method comprising:
receiving compressed data; and
decoding the compressed data, wherein the decoding comprises,
setting at least one parameter, derived from the compressed data, of a decode operation by a hardware accelerator, using a programmable element; and
performing the decode operation using the hardware accelerator.

20. The method of claim 19, wherein performing the decode operation comprises performing a deblock filter operation of a video frame in the compressed data that is decompressed and wherein setting the at least one parameter comprises setting a type of filter for the deblock filter operation and identifying an edge of a block in the video frame to be filtered.

21. The method of claim 19, wherein performing the decode operation comprises performing a motion compensation operation on video frames in the compressed data, wherein setting the at least one parameter comprises setting a type of interpolation for the motion compensation operation.

22. A method comprising:
programming a programmable element and a hardware accelerator to decode a first compressed data based a first decode standard;
decoding the first compressed data using the first decode standard, wherein the decoding comprises,
setting a parameter, derived from the first compressed data and according to a first decode standard, of a first decode operation by a hardware accelerator, using a programmable element; and
performing the first decode operation using the first decode standard using the hardware accelerator;
reprogramming the programmable element and the hardware accelerator to decode a second compressed data based on a second decode standard; and
decoding the second compressed data using the second decode standard, wherein the decoding comprises,
setting a parameter, derived from the second compressed data and according to a second decode standard, of a second decode operation by a hardware accelerator, using a programmable element; and
performing the second decode operation using the second decode standard using the hardware accelerator.

23. The method of claim 22, wherein performing the first decode operation comprises performing a deblock filter operation of a video frame in the compressed data that is decompressed and wherein setting the parameter according to the first decode standard comprises setting a type of filter for the deblock filter operation and identifying an edge of a block in the video frame to be filtered.

24. The method of claim 22, wherein performing the second decode operation comprises performing a motion compensation operation on video frames in the second compressed data, wherein setting the parameter comprises setting a type of interpolation for the motion compensation operation.
